(19) United States
(12) Patent Application Publication
(10) Pub. No.: US 2005/0223869 A1
(43) Pub. Date: Oct. 13, 2005

(54) Spiral slice potato cutter

(75) Inventor: James Alfred White, Pineville, LA (US)

Correspondence Address: JAMES ALFRED WHITE, 909 HWY 1204, PINEVILLE, LA, 71360-2912, US

(73) Assignee: Allied Trading and Marketing Co., Inc., Pineville, LA (US)

(21) Appl. No.: 10/822,276

(22) Filed: Apr. 12, 2004

(51) Int. Cl. B26D 3/08

(52) U.S. Cl. 83/879; 83/733

(57) ABSTRACT

This subject invention enables the cutting of a whole raw potato by the operator into a fixed thickness continuous spiral slice for cooking as deep frying a potato chip. A fixed pilot pin and a threaded spindle with driver attached support the potato in position in front of the single angled blade. Precise thickness of the slice is achieved by the turning of the ⅜-16 threaded spindle by means of an attached handle. The requirement of two hand operation is an intentional safety factor in the design. It prevents the hands from being in a position to contact the sharp blade and/or sharp driver during operation of the invention.

### CROSS REFERENCE TO RELATED APPLICATIONS

Title: SPIRAL SLICE POTATO CUTTER

Reference: Provisional Patent No. 60/451,670
Granted Apr. 17, 2003
Titled: Spiral Slice Potato Cutter

### STATEMENT REGARDING FEDERALLY SPONSORED RESEARCH OR DEVELOPMENT

Not Applicable

### REFERENCE TO SEQUENCE LISTING, TABLE OR COMPUTER PROGRAM LISTING COMPACT DISC APPENDIX

Not Applicable

### BACKGROUND OF INVENTION

An existing cutter/blade that consists of a hand-held, hand-operated blade is commercially available. No patent was found for this cutter/blade in the search. This cutter/blade has a coarse threaded plastic pilot in one end and a large finger hole in the opposite end. A potato is held by hand and the threaded pilot is inserted into the potato. A finger on the other hand is placed into the hole on the opposite end of the blade. The potato is held stationary and the blade rotated in a clockwise direction, with each 360-degree revolution cutting a spiral slice. This device lacks control as the flexible blade bends to forward blade pressure resulting in a thicker slice. Insufficient pressure on the blade results in the disengagement of the blade from the potato as it rotates. Risk of injury is present from this cutter/blade as both hands are exposed to the sharp blade. Poor performance in thin spiral slicing and risk of injury initiated the experimentation and design/development effort which resulted in the subject spiral slice Potato Cutter submitted for patent in this application.

In this present invention a base mounted, angled blade with integrated fixed pilot pin provides for consistently slicing a thin continuous spiral slice. A handle is rotated in a clockwise direction turning a potato and forcing it into the blade. Most present inventions found in the search consist of a series of blades perpendicular to a single blade and produce strips commonly referred to as curlicue or helical strips. Of the existing devices reviewed in the search most were motorized and appear for commercial/industrial high volume applications.

This present invention using a single blade produces a flat continuous spiral slice of fixed thickness and relates to a potato chip excepting its being a continuous form. This invention allows in its simplicity of design and modest cost to provide home consumers with the ability to generate thin uniform slices without hand knife cutting. It is simple in operation and generates a spiral slice utilizing approximately 90% of the potato but leaving a stub end uncut. The uncut stub end may be discarded, as full utilization appears of low consequence in home use.

### BRIEF SUMMARY OF INVENTION

The subject spiral slice potato cutter is designed to cut whole raw potatoes into consistent spiral slice thickness suitable for frying as a potato chip. The design provides for keeping the operators hands away from the sharp elements of the cutter when it is being operated. It employs both hands in a safe position, one holding a guide with threaded drive nut into position against the threaded spindle, while the other hand is actively turning a crank handle. The resultant continuous spiral sliced potato is accumulated at a position behind the blade holder for safe pick up and processing in cooking as frying.

### BRIEF DESCRIPTION OF THE VIEWS OF THE DRAWING

The Drawing 1/1 shows FIG. 1 and FIG. 2.

FIG. 1 is a left side view of the invention listing the component parts with reference number. It shows overall height and length in inches. Dashed lines show on the drive spindle 2 and represent threads on the outside diameter.

FIG. 2 is a topside view of the invention showing the component parts assembled on the top of the base but not listing name or number. It shows overall width in inches. Solid lines show parts assembled on the top of the base. Parts assembled on the bottom of the base in FIG. 2 are shown with dash lines except for the dash lines on the drive spindle which represent threads.

### DETAILED DESCRIPTION OF THE INVENTION

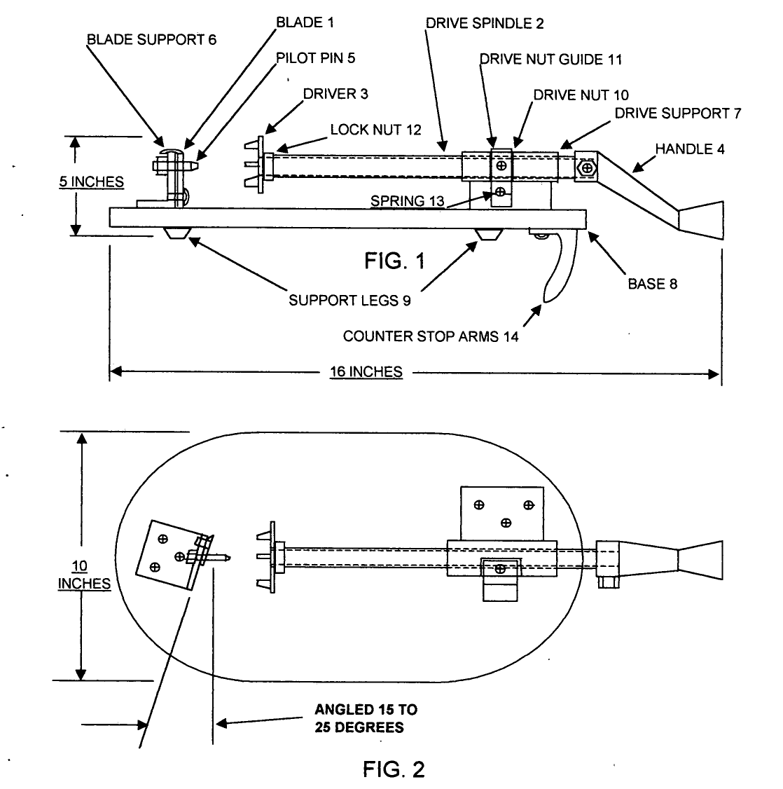

This present invention is a manually operated device designed for use in cutting a potato into a thin continuous spiral slice and is illustrated in Drawing 1/1. Drawing 1/1 FIG. 1 is a left-hand side view of the invention and FIG. 2 is a topside view of the invention.

It utilizes a fixed blade 1 and rotates a potato with a threaded drive spindle 2 with driver 3 to move the potato forward into the blade 1 by use of a rotated crank handle 4. The blade 1 is angled from 15 degrees to 25 degrees from perpendicular to the centerline of the drive spindle and this blade 1 has a hole through which a pilot pin 5 extends to provide support for the potato end opposite the driver 3. Drive support 7 has a right angled bottom and tubular top which has a window opening allowing for the drive nut 10 to contact the drive spindle 2. The blade holder 6 and the drive support 7 are attached to a base 8 made of wood or a composite material which has support legs 9 to stabilize it's use on a smooth flat surface and counter stop arms 14 to stabilize against the surface edge.

An internally threaded drive nut 10 attached to drive nut guide 11 is engaged against the threaded drive spindle 2 to effect a forward thrust of the potato as it rotates into the blade 1. The drive nut 10 is actuated by placing a finger into an opening in the spring 13 mounted drive nut guide 11 with thumb pressure against the top of the drive nut guide tilting the drive nut 10 into position against the threaded spindle 2.

In use the invention is placed on a smooth flat surface with the counter stops 14 against the edge of the surface and the handle 4 toward the operator. The operator using the right-hand grasps the handle 4 and pulls it causing the driver 3 to be moved to the extreme rear position away from the pilot pin 5 and blade 1. A potato is placed against the pilot pin 5 and gently pushed forward so the potato is fully onto the pilot pin 5 and against the blade 1. The opposite end of the potato is positioned directly in front of the driver 3.

The handle 4 is pushed forward until the driver 3 teeth fully penetrate the potato. The left-hand second finger is positioned in the drive nut guide 11 and the first finger placed behind the drive support 7. The thumb is placed on top of the drive nut guide 11 directly over the drive nut 10 and light pressure is applied so the drive nut 10 and drive spindle 2 threads are fully engaged. Light pressure is maintained on the drive nut 10 with the thumb and the right hand then turns the handle 4 in a clockwise direction. After a few revolutions of the handle 4 the potato will contact the blade 1 and start the spiral cut. The handle 4 continues to be turned until the potato is cut and the visible part of the driver 3 is approximately one half inch from the blade 1. Light pressure is felt by the hand on the crank 4 as the drive spindle 2 contacts the pilot pin 5 and the blade support 6 starts to deflect.

The thumb is released from its position on the drive nut guide 11 and the drive nut 10 disengages from the drive spindle 2 stopping forward movement of the potato. The handle 4 is pulled backward and the driver 3 is then away from the pilot pin 5.

The stub end of the potato is then carefully removed from the driver 3. This completes the operation of the invention in the cutting of a potato into a thin continuous spiral slice.

1. An apparatus for cutting a potato into a thin continuous spiral slice comprising:
a fixed vertical blade attached to a blade support and angled horizontally from 15 degrees to 25 degrees from perpendicular to the centerline of the drive spindle with 20 degrees being optimal with the blade sharpened one side for cutting.
a adjustable pilot pin extending through a hole in the blade, in alignment with the drive spindle centerline and secured in its adjusted position by a lock nut; the pilot to position and support the potato at the immediate cutting edge of the blade.
a feed controlled rotary and forward motion through manual cranking of a ⅜″-16 threaded spindle to produce a continuous spiral slice of 0.0625 inch thickness.
a drive nut guide holding the drive nut positions and actuates manually the drive nut to engage the drive spindle to cause forward motion of the drive spindle it being assembled internal to the drive support.
a four toothed driver located at the forward end of the drive spindle and secured by a lock nut; the driver penetrates the potato and transfers the forward and rotary motion of the hand cranked drive spindle to the potato thus forcing it into the sharp edge of the cutting blade.
a base for mounting the blade support and drive support sub-assemblies using four rubber support legs and two counter stop arms to stabilize the apparatus in use.
